(19) United States
(12) Patent Application Publication
(10) Pub. No.: US 2022/0212120 A1
(43) Pub. Date: Jul. 7, 2022

(54) IMPROVED DISTILLATION CAPABILITY BY DILUTION WITH A COMPONENT TO BE SEPARATED OFF

(71) Applicant: Covestro Intellectual Property GmbH & Co. KG, Leverkusen (DE)

(72) Inventors: Jan Suetterlin, Köln (DE); Helen Hermes, Langenfeld (DE); Thomas Fischer, Köln (DE); Joachim Stump, Köln (DE); Ulrich Geron, Köln (DE)

(21) Appl. No.: 17/612,065

(22) PCT Filed: Jun. 20, 2020
(86) PCT No.: PCT/EP2020/064043

§ 371 Date: Nov. 17, 2021

(30) Foreign Application Priority Data
May 27, 2019 (EP) 19176689.8

(51) Int. Cl. B01D 3/34; C08G 18/73; C08G 18/48; C08J 9/12; B01D 3/12

(52) U.S. Cl. CPC B01D 3/34; C08G 18/73; C08G 18/4845; C08J 2375/08; B01D 3/12; C08J 2203/10; C08J 9/125

(57) ABSTRACT

The invention relates to a method for purifying at least one reaction product of at least one diisocyanate, comprising at least the following steps: (A) providing a mixture A at least containing the at least one reaction product of the at least one diisocyanate and, if applicable, the at least one diisocyanate, (B) adding, if applicable more of, at lease one diisocyanate to mixture A from step (A) in order to obtain a mixture B, and (C) separating off the at least one diisocyanate from mixture B from step (B) by distillation in order to obtain the purified at least one reaction product of the at least one diisocyanate. Furthermore, the present invention comprises the reaction product of at least one diisocyanate which can be obtained by the method according to the invention and the use thereof for producing polyurethane foams, polyurethane hydrogels, polyurethane elastomers, varnishes and bonding adhesives.

The invention relates to a process for purifying at least one reaction product of at least one diisocyanate comprising at least the steps of: (A) providing a mixture A at least containing the at least one reaction product of the at least one diisocyanate and optionally the at least one diisocyanate, (B) adding, optionally additional, at least one diisocyanate to mixture A from step (A) to obtain a mixture B and (C) distillatively separating the at least one diisocyanate from mixture B from step (B) to obtain the purified at least one reaction product of the at least one diisocyanate. The present invention further comprises the reaction product of at least one diisocyanate obtainable by the process according to the invention and the use thereof for producing polyurethane foams, polyurethane hydrogels, polyurethane elastomers, coatings and adhesives.

Modification of diisocyanates, for example trimerization, reaction of the at least one diisocyanate with polyols to obtain NCO-terminated prepolymers, urea formation, urethanization, biuretization, allophanatization or combinations of these reactions form the corresponding polyisocyanates, wherein a remainder of unconverted monomeric diisocyanate always remains in the crude product. This remainder is typically removed by a distillation under vacuum and re-used after condensation. An excessively high viscosity, for example above 500 mPas, of the crude product often causes problems since this has an adverse effect on distribution in the distillation apparatus. Special pumps designed for pumping high viscosity liquids are sometimes required.

Processes for reacting diisocyanates and for workup of the reaction mixtures obtained after the reaction are known per se to the person skilled in the art. WO 2018/076199 and EP 0 010 589 A1 each disclose processes for producing trimers based on 2,4- and/or 2,6-toluene diisocyanate and a distillation process for purifying the obtained product. U.S. Pat. No. 4,255,569 discloses a process for producing a trimerization product of a diisocyanate. An inert distillation aid is added for the distillative purification of the obtained reaction mixture.

Proceeding from this prior art, it is an object of the present invention to remedy at least one, preferably two or more, of the abovementioned disadvantages of the prior art. The present invention especially has for its object to provide a process for purifying reaction products of diisocyanates wherein the previously prevailing disadvantages, for example insufficient conveyability of the crude product and/or insufficient separation performance in the distillation, can be avoided. It is a further object of the present invention to provide a corresponding process which not only provides the desired product in high purity, i.e. with a low residual content of monomers, but also provides the separated diisocyanate in high quality, i.e. in high purity.

According to the invention this object was solved by the process for purifying at least one reaction product of at least one diisocyanate comprising at least the steps of:
(A) providing a mixture A at least containing the at least one reaction product of the at least one diisocyanate and optionally the at least one diisocyanate,
(B) adding, optionally additional, at least one diisocyanate to mixture A from step (A) to obtain mixture B,
(C) distillatively separating the at least one diisocyanate from mixture B from step (B) to obtain the purified reaction product of the at least one diisocyanate.

The objects are further achieved according to the invention by a reaction product of at least one diisocyanate obtainable by the process according to the invention, by the use thereof for producing polyurethane foams, polyurethane hydrogels, polyurethane elastomers, coatings and adhesives and by a process for producing polyurethane foams.

The individual steps of the process according to the invention are described in detail hereinbelow:

Step (A) of the process according to the invention comprises providing a mixture A at least containing the at least one reaction product of the at least one diisocyanate and optionally the at least one diisocyanate.

The process according to the invention may generally be used for treatment of any reaction product known to those skilled in the art of at least one diisocyanate provided the production thereof affords a mixture containing the reaction product of the at least one diisocyanate and optionally the at least one diisocyanate (mixture A).

In a preferred embodiment the present invention relates to the process according to the invention, wherein mixture A is obtained by trimerization of the at least one diisocyanate, reaction of the at least one diisocyanate with polyols to obtain NCO-terminated prepolymers, urea formation, urethanization, biuretization, allophanatization, carbodiimidization, uretdione formation, uretonimine formation, oxazolidone formation, amide formation or combinations of these reactions.

Corresponding processes for carrying out the abovementioned reactions are known per se to the person skilled in the art and are described, for example, in J. Prakt. Chem. 336 (1994) 185-200, DE-A 1 670 666, DE-A 1 954 093, DE-A 2 414 413, DE-A 2 452 532, DE-A 2 641 380, DE-A 3 700 209, DE-A 3 900 053, DE-A 3 928 503, EP-A 0 336 205, EP-A 0 339 396 and EP-A 0 798 299.

Preference is given to the reaction of the at least one diisocyanate with at least one polyol to obtain NCO-terminated prepolymers. The reaction of the at least one diisocyanate with at least one polyol is for example carried out at a temperature of preferably 50° C. to 130° C., particularly preferably at 60° C. to 120° C. Suitable catalysts for the reaction of the at least one diisocyanate with at least one polyol are for example selected from the group consisting of catalytically active metal salts, amines, amidines, guanidines and mixtures thereof. Examples include dibutyltin dilaurate (DBTL), tin acetate, 1,8-diazabicyclo[5.4.0]undecene-7 (DBU), 1,5-diazabicyclo[4.3.0]nonene-5 (DBN), 1,4-diazabicyclo[3.3.0]octene-4 (DBO), N-ethylmorpholine (NEM), triethylenediamine (DABCO), pentamethylguanidine (PMG), tetramethylguanidine (TMG), cyclotetramethylguanidine (TMGC), n-decyltetramethylguanidine (TMGD), n-dodecyltetramethylguanidine (TMGDO), dimethylaminoethyltetramethylguanidine (TMGN), 1,1,4,4,5,5-hexamethylisobiguanidine (HMIB), phenyltetramethylguanidine (TMGP) and hexamethyleneoctamethylbiguanidine (HOBG).

Suitable polyols are selected for example from the group consisting of polyether polyols, polyester polyols, polycarbonate polyols, polysiloxane polyols and mixtures thereof. It is particularly preferable according to the invention to employ polyether polyols, in particular polymers of ethylene oxide and/or propylene oxide.

It is also possible according to the invention for a plurality of the abovementioned reactions to be carried out simultaneously so that performance of the reaction affords for example a mixture which contains not only the reaction product of the at least one diisocyanate with at least one polyol and the product of the trimerization of the at least one diisocyanate but also the at least one diisocyanate itself. It is preferable according to the invention when the in step (A) of the process according to the invention contains substantially, i.e. to an extent of at least 5% by weight, preferably to an extent of at least 10% by weight, particularly preferably to an extent of at least 30% by weight, a reaction product of at least one diisocyanate, in particular of one diisocyanate.

It is possible and preferable according to the invention for step (A) to afford a mixture containing the reaction product of the at least one diisocyanate and the at least one diisocyanate. It is also possible, but less preferable, according to the invention for step (A) to afford a mixture containing the reaction product of the at least one diisocyanate but not the at least one diisocyanate.

According to the invention the at least one diisocyanate is selected from the group consisting of diisocyanates having aliphatically, cycloaliphatically, araliphatically and/or aromatically bonded isocyanate groups.

The at least one diisocyanate is particularly preferably selected from the group consisting of hexamethylene diisocyanate (HDI), isophorone diisocyanate (IPDI), butylene diisocyanate (BDI), pentamethylene diisocyanate (PDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate (XDI), tetramethylxylylene diisocyanate, norbornane diisocyanate, cyclohexane diisocyanate, toluene 2,4-diisocyanate (2,4-TDI), toluene 2,6-diisocyanate (2,6-TDI), 2,2′-methylenediphenyl diisocyanate (2, 2′-MDI), 2,4′-methylenediphenyl diisocyanate (2,4′-MDI), 4,4′-methylenediphenyl diisocyanate (4,4′-MDI) and mixtures thereof. The at least one diisocyanate is very particularly preferably selected from the group consisting of hexamethylene diisocyanate (HDI), isophorone diisocyanate (IPDI), butylene diisocyanate (BDI), pentamethylene diisocyanate (PDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate (XDI), tetramethylxylylene diisocyanate, norbornane diisocyanate, cyclohexane diisocyanate, toluene 2,4-diisocyanate (2,4-TDI), toluene 2,6-diisocyanate (2,6-TDI) and mixtures thereof.

The content of the at least one diisocyanate in mixture A can depend on the reaction by which the respective reaction product is obtained. It is preferable according to the invention when mixture A contains the at least one diisocyanate in an amount of 0.1% to 90% by weight, particularly preferably 2% to 80% by weight, in each case based on mixture A.

In the process according to the invention mixture A preferably has a viscosity of 500 to 50 000 mPas, preferably 1000 to 10 000 mPas. This elevated viscosity of the mixture A obtained according to the invention is disadvantageous for the necessary distillation for separating the unconverted at least one diisocyanate. Viscosity is determined at 23° C. according to DIN 53019.

Step (B) of the process according to the invention comprises adding, optionally additional, diisocyanate to mixture A from step (A) to obtain a mixture B.

In the embodiment according to the invention where step (A) comprises providing a mixture A at least containing the at least one reaction product of the at least one diisocyanate and the at least one diisocyanate step (B) comprises adding further diisocyanate to the mixture A from step (A) to obtain a mixture B.

In the embodiment according to the invention where step (A) comprises providing a mixture A at least containing the at least one reaction product of the at least one diisocyanate but not the at least one diisocyanate step (B) comprises adding diisocyanate to the mixture A from step (A) to obtain a mixture B.

According to the invention the at least one diisocyanate added in step (B) is the same as that previously employed in step (A). This has the advantage according to the invention that the subsequent distillation step (C) need only comprise separating one compound and not two or more compounds.

It is preferable when step (B) of the process according to the invention comprises adding a sufficient amount of the at least one diisocyanate for the viscosity of the mixture B to be low enough for advantageous distillation according to the invention. It is preferable when mixture B has a viscosity of 100 to 1400 mPas, preferably 150 to 1000 mPas. Viscosity is determined at 23° C. according to DIN 53019.

In a preferred embodiment of the process according to the invention step (B) comprises adding the at least one diisocyanate in an amount of 1% to 60% by weight, preferably 5% to 50% by weight, particularly preferably 8% to 45% by weight, in each case based on mixture A.

Accordingly mixture B preferably contains the at least one diisocyanate in an amount of 1% to 94% by weight, particularly preferably 9% to 86% by weight, based on the mixture B.

Step (C) of the process according to the invention comprises distillatively separating the diisocyanate from mixture B from step (B) to obtain the purified reaction product of the at least one diisocyanate.

Processes for purifying reaction mixtures of at least one diisocyanate by distillation are known per se to those skilled in the art.

Mixture B which is subjected to distillative treatment in step (C) of the process according to the invention contains the at least one reaction product of the at least one diisocyanate, the at least one diisocyanate and optionally also further byproducts which depend on the reaction performed in each case. It is preferable when mixture B contains only the at least one reaction product of the at least one diisocyanate and the at least one diisocyanate. Step (C) of the process according to the invention thus preferably comprises distillatively separating the at least one diisocyanate to free the at least one reaction product of the excess at least one diisocyanate.

Since in a preferred embodiment of the process according to the invention the at least one diisocyanate preferably has a lower boiling point than the at least one reaction product it is preferable when the at least one diisocyanate is distillatively separated from the at least one reaction product.

The distillation in step (C) of the process according to the invention may generally be carried out by any process known to those skilled in the art.

The present invention preferably relates to the process according to the invention, wherein the distillative separation in step (C) is carried out at a temperature of 105° C. to 235° C., preferably 110° C. to 160° C.

In a preferred embodiment step (C) of the process according to the invention is carried out by molecular distillation, for example using a short path evaporator, thin-film evaporator, falling-film evaporator or combinations thereof. Step (C) of the process according to the invention is especially preferably carried out in a combination of a pre-evaporator and a main evaporator. The temperature in the pre-evaporator is preferably 5° C. to 20° C., particularly preferably 5° C. to 15° C., higher than in the main evaporator. The pre-evaporator and main evaporator are preferably operated at the same pressure.

In step C of the process according to the invention the pressure may generally be chosen by those skilled in the art so as to allow, according to the chosen temperature, distillative removal of the at least one diisocyanate. The present invention preferably relates to the process according to the invention, wherein the distillative separation in step (C) is carried out at a pressure of 0.01 to 10 mbar (a), preferably 0.1 to 1 mbar (a).

Step (C) of the process according to the invention is preferably performed such that firstly the desired product is obtained in the highest possible purity, i.e. ideally free from at least one diisocyanate, and secondly the at least one diisocyanate is obtained in the highest possible purity. The present invention therefore preferably relates to the process according to the invention, wherein the purified at least one reaction product of the at least one diisocyanate obtained in step (C) has a content of at least one diisocyanate of 0.001% to 0.5% by weight based on the reaction product.

The present invention further relates to the process according to the invention, wherein the at least one diisocyanate separated in step (C) is obtained in a purity of at least 96% by weight, particularly preferably at least 97% by weight. The purity is preferably not more than 99.99% by weight.

For the particularly preferred case where 1,6-hexamethylene diisocyanate is employed as the diisocyanate the distillate obtained in step (C) according to the present invention, i.e. 1,6-hexamethylene diisocyanate (HDI), preferably has an NCO content of at least 49.0% by weight, particularly preferably at least 49.1% by weight. The NCO content is preferably not more than 50% by weight.

According to the present invention the product obtained in step (C), i.e. preferably the at least one reaction product of the at least one diisocyanate, preferably has a residual diisocyanate content of not more than 0.5% by weight, preferably not more than 0.3% by weight. The NCO content is preferably at least 0.01% by weight. The residual diisocyanate content is determined by gas chromatography according to DIN EN ISO 10283.

According to the present invention the product obtained in step (C), i.e. preferably the at least one reaction product of the at least one diisocyanate, preferably has a content of compounds having a molecular weight of less than 1000 g/mol of 0.1% to 50% by weight, particularly preferably 0.5% to 10% by weight.

According to the present invention the product obtained in step (C), i.e. preferably the at least one reaction product of the at least one diisocyanate, preferably has a viscosity of 500 to 100 000 mPas, particularly preferably 1000 to 50 000 mPas. Viscosity is determined at 23° C. according to DIN 53019.

The at least one diisocyanate separated in step (C) of the process according to the invention may according to the invention particularly advantageously be employed in the synthesis of additional at least one reaction product of the at least one diisocyanate according to step (A) or for diluting the reaction solution according to step (B) of the process according to the invention

The present invention therefore preferably relates to the process according to the invention, wherein the at least one diisocyanate distillatively separated in step (C) is at least in part used for producing the reaction product present in mixture A.

The present invention preferably further relates to the process according to the invention, wherein the at least one diisocyanate distillatively separated in step (C) is at least in part employed in step (B).

It has surprisingly been found that the purity of the at least one diisocyanate which is separated in step C in the process according to the invention is higher than the purity of at least one diisocyanate obtained by distillation without optionally further diisocyanate having been added previously, The observed effect goes beyond purely the dilution effect. That this is due to a surprisingly more efficient distillative separation is also apparent from the higher proportion of oligomers below 1000 g/mol, for example dimers and trimers, in the reaction product.

The present invention also relates to the reaction product of at least one diisocyanate obtainable by the process according to the invention.

In particular the present invention relates to the reaction product according to the invention, wherein said product is an NCO-terminated prepolymer.

The present invention further preferably relates to the at least one reaction product of the at least one diisocyanate, wherein said product comprises a residual diisocyanate content of not more than 0.5% by weight, preferably not more than 0.3% by weight. The NCO content is preferably at least 0.001% by weight.

The present invention further preferably relates to at least one reaction product of the at least one diisocyanate, wherein said product has a content of compounds having a molecular weight of less than 1000 g/mol of 0.1% to 50% by weight, particularly preferably 0.5% to 10% by weight.

The present invention further preferably relates to the at least one reaction product of the at least one diisocyanate, wherein said product has a viscosity of 500 to 100 000 mPas, particularly preferably 1000 to 50 000 mPas. Viscosity is determined at 23° C. according to DIN 53019.

The present invention also to the use of the reaction product according to the invention for producing polyurethane foams, polyurethane hydrogels, polyurethane elastomers, coatings and adhesives.

The present invention also relates to a process for producing polyurethane foams, wherein a composition comprising a reaction product according to the invention, water, optionally oligomers produced from at least two low molecular weight diisocyanates, wherein the diisocyanates have a molar mass of 140 bis 278 g/mol, optionally catalysts, optionally salts of weak acids, whose corresponding free acids in water at 25° C. have a pKₐ value of ≥3.0 and ≤14.0, optionally surfactants, optionally mono- or polyhdric alcohols or polyols, optionally hydrophilic polyisocyanates, is provided, foamed and cured.

Processes for producing polymer foams are known per se to those skilled in the art and are described for example in U.S. Pat. No. 7,790,778 B2 or EP 2 585 121 B1.

In a first embodiment the invention relates to a process for purifying at least one reaction product of at least one diisocyanate comprising at least the steps of:

(A) providing a mixture A at least containing the at least one reaction product of the at least one diisocyanate and optionally the at least one diisocyanate,

(B) adding, optionally additional, at least one diisocyanate to mixture A from step (A) to obtain mixture B,

(C) distillatively separating the at least one diisocyanate from mixture B from step (B) to obtain the purified at least one reaction product of the at least one diisocyanate.

In a second embodiment the invention relates to a process according to embodiment 1, characterized in that mixture A is obtained by trimerization of the at least one diisocyanate, reaction of the at least one diisocyanate with polyols to obtain NCO-terminated prepolymers, urea formation, urethanization, biuretization, allophanatization, carbodiimidization, uretdione formation, uretonimine formation, oxazolidone formation, amide formation or combinations of these reactions.

In a third embodiment, the invention relates to a process according to embodiment 1 or 2, characterized in that mixture A contains the at least one diisocyanate in an amount of 0.1% to 90% by weight based on mixture A.

In a fourth embodiment, the invention relates to a process according to any of embodiments 1 to 3, characterized in that mixture B contains the at least one diisocyanate in an amount of 1% to 94% by weight based on the mixture B.

In a fifth embodiment the invention relates to a process according to any of embodiments 1 to 4, characterized in that step (B) comprises adding the at least one diisocyanate in an amount of 1% to 60% by weight, preferably 5% to 50% by weight, particularly preferably 8% to 45% by weight, in each case based on mixture A.

In a sixth embodiment the invention relates to a process according to any of embodiments 1 to 5, characterized in that the purified at least one reaction product of the at least one diisocyanate obtained in step (C) has a content of at least one diisocyanate of 0.001% to 0.5% by weight based on the at least one reaction product.

In a seventh embodiment the invention relates to a process according to any of embodiments 1 to 6, characterized in that the mixture A has a viscosity of 500 to 50 000 mPas, preferably 1000 to 10 000 mPas, wherein viscosity is determined at 23° C. according to DIN 53019.

In an eighth embodiment the invention relates to a process according to any of embodiments 1 to 7, characterized in that mixture B has a viscosity of 100 to 1400 mPas, preferably 150 to 1000 mPas, wherein viscosity is determined at 23° C. according to DIN 53019.

In a ninth embodiment the invention relates to a process according to any of embodiments 1 to 8, characterized in that the at least one diisocyanate is selected from the group consisting of diisocyanates having aliphatically, cycloaliphatically, araliphatically and/or aromatically bonded isocyanate groups.

In a tenth embodiment the invention relates to a process according to any of embodiments 1 to 9, characterized in that the at least one diisocyanate is selected from the group consisting of hexamethylene diisocyanate (HDI), isophorone diisocyanate (IPDI), butylene diisocyanate (BDI), pentamethylene diisocyanate (PDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate (XDI), tetramethylxylylene diisocyanate, norbornane diisocyanate, cyclohexane diisocyanate, toluene 2,4-diisocyanate (2,4-TDI), toluene 2,6-diisocyanate (2,6-TDI), 2,2′-methylenediphenyl diisocyanate (2, 2′-MDI), 2,4′-methylenediphenyl diisocyanate (2,4′-MDI), 4,4′-methylenediphenyl diisocyanate (4,4′-MDI) and mixtures thereof.

In an eleventh embodiment the invention relates to a process according to any of embodiments 1 to 10, characterized in that the distillative separation in step (C) is carried out at a temperature of 105° C. to 235° C., preferably 110° C. to 160° C.

In a twelfth embodiment the invention relates to a process according to any of embodiments 1 to 11, characterized in that the distillative separation in step (C) is carried out at a pressure of 0.01 to 10 mbar (a), preferably 0.1 to 1 mbar (a).

In a thirteenth embodiment the invention relates to a process according to any of embodiments 1 to 12, characterized in that the at least one diisocyanate distillatively separated in step (C) is at least in part used for producing the at least one reaction product present in the mixture A.

In a fourteenth embodiment the invention relates to a process according to any of embodiments 1 to 13, characterized in that the at least one diisocyanate distillatively separated in step (C) is at least in part employed in step (B).

In a fifteenth embodiment the invention relates to a process according to any of embodiments 1 to 14, characterized in that the at least one diisocyanate separated in step (C) is obtained in a purity of at least 96% by weight, particularly preferably at least 97% by weight.

In a sixteenth embodiment the invention relates to a process according to any of embodiments 1 to 15, characterized in that the at least one diisocyanate is selected from the group consisting of hexamethylene diisocyanate (HDI), isophorone diisocyanate (IPDI), butylene diisocyanate (BDI), pentamethylene diisocyanate (PDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate (XDI), tetramethylxylylene diisocyanate, norbornane diisocyanate, cyclohexane diisocyanate, toluene 2,4-diisocyanate (2,4-TDI), toluene 2,6-diisocyanate (2,6-TDI) and mixtures thereof.

In a seventeenth embodiment the invention relates to a reaction product of at least one diisocyanate obtainable by the process according to any of embodiments 1 to 16.

In an eighteenth embodiment the invention relates to a reaction product according to embodiment 17, characterized in that said product is an NCO-terminated prepolymer.

In a nineteenth embodiment the invention relates to a use of the at least one reaction product according to embodiment 17 or 18 for producing polyurethane foams, polyurethane hydrogels, polyurethane elastomers, coatings and adhesives.

In a twentieth embodiment the invention relates to a process for producing polyurethane foams, characterized in that a composition comprising at least one reaction product according to embodiment 17 or 18, water, optionally oligomers produced from at least two low molecular weight diisocyanates, wherein the diisocyanates have a molar mass of 140 bis 278 g/mol, optionally catalysts, optionally salts of weak acids, whose corresponding free acids in water at 25° C. have a pKₐ value of ≥3.0 and ≤14.0, optionally surfactants, optionally mono- or polyhdric alcohols or polyols, optionally hydrophilic polyisocyanates, is provided, foamed and cured.

The examples according to the invention and the comparative examples are intended to more particularly describe the present invention without being interpreted as limiting.

### EXAMPLES

2960 g of a polyalkylene oxide started from 1,3-propylene glycol having a molar mass of 591 g/mol and an OH number of 190 mg KOH/g and a proportion by weight of ethylene oxide of 87% were added dropwise to a mixture of 1680 g of 1,6-hexamethylene diisocyanate (HDI) and 5.0 g of dibutyl phosphate at 80° C. over 30 min and the resulting mixture was stirred for a further 3.5 h until an NCO content of 9.1% was attained.

For the individual experiments this mixture was in each case diluted with HDI according to table 1 to obtain the corresponding starting mixtures (SM). The mixture obtained from the abovementioned synthesis (experiments V1, V2 and V3) and the starting mixtures (experiments 4, 5, 6, 7, 8 and 9) were distilled at the temperatures recited in table 1 (VV: pre-evaporator, HV: main evaporator) and in each case at a pressure of 0.7 mbar (a). The obtained distillates/the distillate residues which constitute the respective product were subsequently subjected to determination in each case of the NCO content of the distillate, the HDI content of the distillate, the NCO content of the product, the viscosity of the product, the weight average molecular weight (Mw) of the product, the residual HDI content of the product and the proportion of compounds having a molecular weight below 1000 g/mol by the methods reported below.

The recited measured values are determined by the following methods:

Unless otherwise stated all percentages are based on weight.

Viscosity was determined at 23° C. according to DIN 53019.

NCO contents were determined by volumetric means according to DIN-EN ISO 11909.

The weight average molecular weight (Mw), the proportion below 1000 g/mol and the HDI content of the distillate were determined by gel permeation chromatography (GPC) in the solvent THF according to DIN 55672-1.

The residual HDI content was determined by gas chromatography according to DIN EN ISO 10283.

TABLE 1

| | | | | | | | | | | Content of |
|---|---|---|---|---|---|---|---|---|---|---|
| | | | | | | | | | Residual | compounds |
| | HDI | Viscosity | Distillation | NCO | HDI | NCO | Viscosity | | HDI | with |
| | added | of starting | temperature | content of | content of | content of | of | Mw of | content | M < 1000 |
| | [% by | mixture | (VV/HV) | distillate | distillate | product | product | product | of product | g/mol |
| Experiment | wt.] | [mPas] | [° C.] | [%] | [%] | [%] | [mPas] | [%] | [%] | [%]¹ |
| V1 | 0 | 1780 | 130/120 | 48.9 | 95 | 5.0 | 4330 | 3280 | 0.01 | 5.9 |
| V2 | | | 140/130 | 48.7 | 99 | 4.9 | 4430 | 3270 | 0.01 | 6.1 |
| V3 | | | 150/140 | 48.2 | 95 | 4.9 | 4830 | 3380 | 0.02 | 5.9 |
| 4 | 11 | 857 | 130/120 | 49.5 | 97 | 5.0 | 4340 | 3250 | 0.03 | 6.0 |
| 5 | | | 140/130 | 49.2 | 96 | 5.0 | 4390 | 3260 | 0.01 | 6.3 |
| 6 | | | 150/140 | 49.0 | 98 | 5.0 | 4380 | 3260 | 0.01 | 6.1 |
| 7 | 43 | 201 | 130/120 | 49.2 | 100 | 5.2 | 4170 | 3200 | 0.04 | 6.5 |
| 8 | | | 140/130 | 49.2 | 100 | 5.2 | 4230 | 3200 | 0.02 | 6.5 |
| 9 | | | 150/140 | 49.3 | 100 | 5.1 | 4320 | 3260 | 0.01 | 6.2 |

VComparative
¹in the product after distillation

The inventive experiments and the comparative experiments clearly show that the process according to the invention makes it possible to obtain the distillate in particularly high purity, thus allowing reuse thereof for syntheses. The process according to the invention simultaneously allows the reaction product to be diluted, thus allowing simpler conveying thereof.

1: A process for purifying at least one reaction product of at least one diisocyanate comprising the steps of:
(A) providing a mixture A containing the at least one reaction product of the at least one diisocyanate and optionally, the at least one diisocyanate,
(B) adding, optionally additional, at least one diisocyanate to mixture A from step (A) to obtain mixture B,
(C) distillatively separating the at least one diisocyanate from mixture B from step (B) to obtain the purified at least one reaction product of the at least one diisocyanate.

2: The process as claimed in claim 1, wherein mixture A is obtained by one selected from the group consisting of trimerization of the at least one diisocyanate, reaction of the at least one diisocyanate with polyols to obtain NCO-terminated prepolymers, urea formation, urethanization, biuretization, allophanatization, carbodiimidization, uretdione formation, uretonimine formation, oxazolidone formation, amide formation, and combinations of these reactions.

3: The process as claimed in claim 1, wherein mixture A contains the at least one diisocyanate in an amount of 0.1% to 90% by weight based on mixture A.

4: The process as claimed in claim 1, wherein mixture B contains the at least one diisocyanate in an amount of 1% to 94% by weight based on the weight of mixture B.

5: The process as claimed in claim 1, wherein step (B) comprises adding the at least one diisocyanate in an amount of 1% to 60% by weight based on mixture A.

6: The process as claimed in claim 1, wherein the purified at least one reaction product of the at least one diisocyanate obtained in step (C) has a content of at least one diisocyanate of 0.001% to 0.5% by weight based on the at least one reaction product.

7: The process as claimed in claim 1, wherein mixture A has a viscosity of 500 to 50 000 mPas, wherein viscosity is determined at 23° C. according to DIN 53019.

8: The process as claimed in claim 1, in that mixture B has a viscosity of 100 to 1400 mPas wherein viscosity is determined at 23° C. according to DIN 53019.

9: The process as claimed in claim 1, wherein the at least one diisocyanate is selected from the group consisting of diisocyanates having aliphatically, cycloaliphatically, araliphatically and aromatically bonded isocyanate groups.

10: The process as claimed in claim 1, wherein the at least one diisocyanate is selected from the group consisting of hexamethylene diisocyanate (HDI), isophorone diisocyanate (IPDI), butylene diisocyanate (BDI), pentamethylene diisocyanate (PDI), bisisocyanatocyclohexylmethane (HMDI), 2,2,4-trimethylhexamethylene diisocyanate, bisisocyanatomethylcyclohexane, bisisocyanatomethyltricyclodecane, xylylene diisocyanate (XDI), tetramethylxylylene diisocyanate, norbornane diisocyanate, cyclohexane diisocyanate, toluene 2,4-diisocyanate (2,4-TDI), toluene 2,6-diisocyanate (2,6-TDI), 2,2′-methylenediphenyl diisocyanate (2, 2′-MDI), 2,4′-methylenediphenyl diisocyanate (2,4′-MDI), 4,4′-methylenediphenyl diisocyanate (4,4′-MDI), and mixtures thereof.

11: The process as claimed in claim 1, wherein the at least one diisocyanate distillatively separated in step (C) is at least in part used for producing the at least one reaction product present in mixture A.

12: The process as claimed in claim 1, wherein the at least one diisocyanate distillatively separated in step (C) is at least in part employed in step (B).

13: A reaction product of at least one diisocyanate obtained by the process as claimed in claim 1.

14: In a process for producing one selected from the group consisting of polyurethane foams, polyurethane hydrogels, polyurethane elastomers, coatings, and adhesives by reaction of an isocyanate, the improvement comprising including the at least one reaction product as claimed in claim 13.

15: A process for producing polyurethane foams, wherein a composition comprising at least one reaction product as claimed in claim 13, water, optionally oligomers produced from at least two low molecular weight diisocyanates, wherein the diisocyanates have a molar mass of 140 bis 278 g/mol, optionally catalysts, optionally salts of weak acids, whose corresponding free acids in water at 25° C. have a pKₐ value of ≥3.0 and ≤14.0, optionally surfactants, optionally mono- or polyhdric alcohols or polyols, optionally hydrophilic polyisocyanates, is provided, foamed, and cured.

16: The process as claimed in claim 1, wherein step (B) comprises adding the at least one diisocyanate in an amount of 5% to 50% by weight based on mixture A.

17: The process as claimed in claim 1, wherein step (B) comprises adding the at least one diisocyanate in an amount of 8% to 45% by weight based on mixture A.

18: The process as claimed in claim 1, wherein mixture A has a viscosity of 1000 to 10 000 mPas, wherein viscosity is determined at 23° C. according to DIN 53019.

19: The process as claimed in claim 1, in that mixture B has a viscosity of 150 to 1000 mPas, wherein viscosity is determined at 23° C. according to DIN 53019.
